(19) United States
(12) Patent Application Publication
(10) Pub. No.: US 2012/0283975 A1
(43) Pub. Date: Nov. 8, 2012

(54) SAMPLE ANALYZER AND DATA PROCESSING APPARATUS

(76) Inventor: Daigo Fukuma, Kobe-shi (JP)

(21) Appl. No.: 13/456,862

(22) Filed: Apr. 26, 2012

(30) Foreign Application Priority Data
May 2, 2011 (JP) JP2011-102825

(51) Int. Cl. G06F 19/00

(52) U.S. Cl. 702/84

(57) ABSTRACT

A sample analyzer shows, on a display, a screen that includes a first quality control graph plotted by a time-series of quality control values, and a second quality control graph plotted by a time-series of quality control values; wherein when a first number of quality control values are included in the first quality control data in a predetermined period and a second number of quality control values, which is different from the first number, are included in the second quality control data in the predetermined period, the sample analyzer shows, on the screen, the first quality control graph of the first number of quality control values plotted in a range in the direction of the time axis of the graph and a second quality control graph of the second number of the second quality control values plotted in the range

### RELATED APPLICATIONS

This application claims priority under 35 U.S.C. §119 to Japanese Patent Application No. 2011-102825 filed on May 2, 2011, the entire content of which is hereby incorporated by reference.

### BACKGROUND OF THE INVENTION

1. Field of the Invention

The present invention relates to a sample analyzer and data processing apparatus for analyzing samples, such as blood.

2. Description of the Related Art

Quality controls are implemented to verify that accurate measurement results are obtained in facilities that use sample analyzers.

Quality controls are implemented by periodically (for example, daily) measuring a quality control sample to verify that the measurement result is within a set range. For example, U.S. Patent Application Publication No. 2009/0198463 applies to such quality controls.

Sample analyzers that perform quality controls generally are capable of showing a graph of time-series plotted quality control values of measurement results from measuring a quality control sample for predetermined periods (for example, refer to U.S. Patent Application Publication No. 2009/0198463). The quality control data are shown in time series since they are time-series data consisting of a set of quality control values of a predetermined period, hence it is possible to confirm the trend the quality control values in the sample analyzer.

U.S. Patent Application Publication No. 2009/0198463 discloses, in relation to the display of quality control values, a chart for controlling standard deviation values on the vertical axis and dates on the horizontal axis. The control chart shows a plurality of line graphs aligned vertically, the graphs showing the respective measurement results of a plurality of quality control samples having different concentration levels. In U.S. Patent Application Publication No. 2009/0198463, the quality control values (SD values) of a plurality of different quality control samples used on the same day of the week in a single month are plotted at the same position on the horizontal axis.

Thus, the manager of the sample analyzer can compare a plurality of quality control data by simultaneously showing a plurality of quality control data composed of the quality control values of a predetermined period.

The measurement of the quality control sample is not limited to once per day and may be performed a plurality of times in a single day.

Moreover, the number of measurements in the same day may be different in a plurality of quality control data.

For example, when the sample analyzer has a plurality of measuring units, a quality control sample can be measured by a plurality of measuring units at a specific time zone to obtain quality control values for the several measuring units. However, when a specific measuring unit is shut down and not in use in a different time zone, the quality control sample can be measured by the other operating measuring units.

As a result, there are a different number of measurements of the quality control samples during the same day for the quality control data of the specific measuring unit and the quality control data of the other measuring units.

When the plurality of quality control data of different numbers of measurements on each day are plotted in time series, it is difficult to display the plurality of quality control data for easy comparison without special manipulation.

For example, when the quality control values contained in the quality control data are plotted at a prioritized fixed-plot spacing without the concept of a “day” from the plot spacing, the date position becomes skewed on the horizontal axis in a plurality of graphs corresponding to the several quality control data. Hence, it is difficult to compare the plurality of quality control data.

When prioritized to eliminate the skewing of the date position on the horizontal axis, the several plots of different values aggregate on the days in which a plurality of measurements were performed. Hence, it is more difficult to compare the plurality of quality control data.

### SUMMARY OF THE INVENTION

The scope of the present invention is defined solely by the appended claims, and is not affected to any degree by the statements within this summary.

According to a first aspect of the present invention, a sample analyzer comprising: a measuring section for analyzing components in a sample; a memory section for storing first quality control data, which are time-series data that include at least one quality control value obtained by the measuring unit measuring a quality control sample, and second quality control data, which are time-series data that include at least one quality control value; a display; and a processing section for showing, on the display, a screen that includes a first quality control graph plotted by a time-series of quality control values contained in the first quality control data stored in the memory unit, and a second quality control graph plotted by a time-series of quality control values contained in the second quality control data stored in the memory unit; wherein when a first number of quality control values are included in the first quality control data in a predetermined period and a second number of quality control values, which is different from the first number, are included in the second quality control data in the predetermined period, the processing section shows, on the screen, the first quality control graph of the first number of quality control values plotted in a range in the direction of the time axis of the graph and a second quality control graph of the second number of the second quality control values plotted in the range.

According to a second aspect of the present invention, a data processing apparatus, comprising: a memory section for storing first quality control data, which are time-series data that include at least one quality control value obtained by a measuring unit measuring components in a sample, and second quality control data, which are time-series data that include at least one quality control value; a display; and a processing section for showing, on the display, a screen that includes a first quality control graph plotted by a time-series of quality control values contained in the first quality control data stored in the memory unit, and a second quality control graph plotted by a time-series of quality control values contained in the second quality control data stored in the memory unit; wherein when a first number of quality control values are included in the first quality control data in a predetermined period and a second number of quality control values, which is different from the first number, are included in the second quality control data in the predetermined period, the processing section shows, on the screen, the first quality control graph of the first number of quality control values plotted in a range in the direction of the time axis of the graph and a second quality control graph of the second number of the second quality control values plotted in the range.

### BRIEF DESCRIPTION OF THE DRAWINGS

FIG. 1 is a structural diagram of a sample analyzer;

FIG. 2 is a structural diagram of a processing apparatus;

FIGS. 3(a), 3(b), and 3(c) are structural diagrams of a quality control database;

FIG. 4 is a flow chart showing the display processing sequence of the quality control graphs;

FIG. 5 shows a that shows the candidate quality control data for overlay;

FIG. 6 is a flow chart showing the overlay display process;

FIG. 7 illustrates the plotting operation;

FIG. 8 is a chart display screen for each measurement item;

FIG. 9 shows another example of the plotting operation; and

FIG. 10 shows still another example of the plotting operation.

### DETAILED DESCRIPTION OF THE PREFERRED EMBODIMENTS

The embodiments of the sample analyzer of the present invention are described in detail hereinafter with reference to the accompanying drawings.

[1. General Structure]

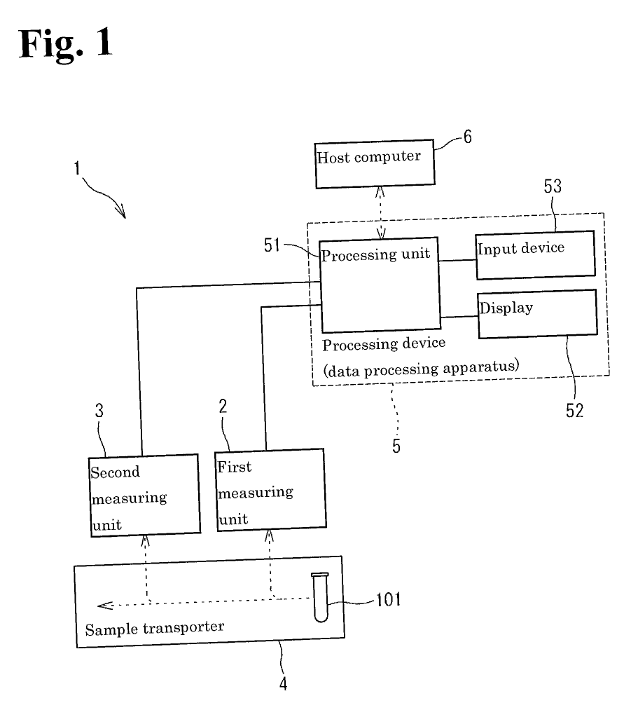

FIG. 1 shows the structure of a blood analyzer 1 as an example of the sample analyzer of the present invention. The blood analyzer 1 is a blood cell counter which counts the cells in a blood sample collected from a subject, and has two measuring units including a first measuring unit 2 and a second measuring unit 3, a sample transporter (sampler) 4 arranged on the front side (bottom side in FIG. 1) of the measuring units 2 and 3, and a processing apparatus (data processing apparatus) 5 electrically connected to the measuring units 2 and 3 and the sample transporter 4. The blood analyzer 1 is connected to a host computer 6 through a network that is not shown in the drawing.

The first measuring unit 2 and the second measuring unit 3 aspirate the blood sample from a sample container 101 that has been transported by the sample transporter, mix reagent with the aspirated blood sample to prepare a measurement sample, detect the blood cells in the measurement sample, and output the analysis results of a plurality of measurement items (for example, RBC, WBC, HCT, MCV, HCM and the like).

The first measuring unit 2 and the second measuring unit 3 are essentially the same type of measuring unit and are mutually adjacent. Specifically, in the present embodiment the second measuring unit 3 uses the same measurement principles as the first measuring unit 2 so they both measure samples for common items. The second measuring unit 3 also measures measurement items that are not analyzed by the first measuring unit 2.

The detection results obtained by the first measuring unit 2 and the second measuring unit 3 are transmitted as sample measurement data (measurement results) to the processing apparatus 5. Note that the measurement data are based on the ultimate analysis results (red blood cell count, platelet count, hemoglobin, white blood cell count) provided to the user.

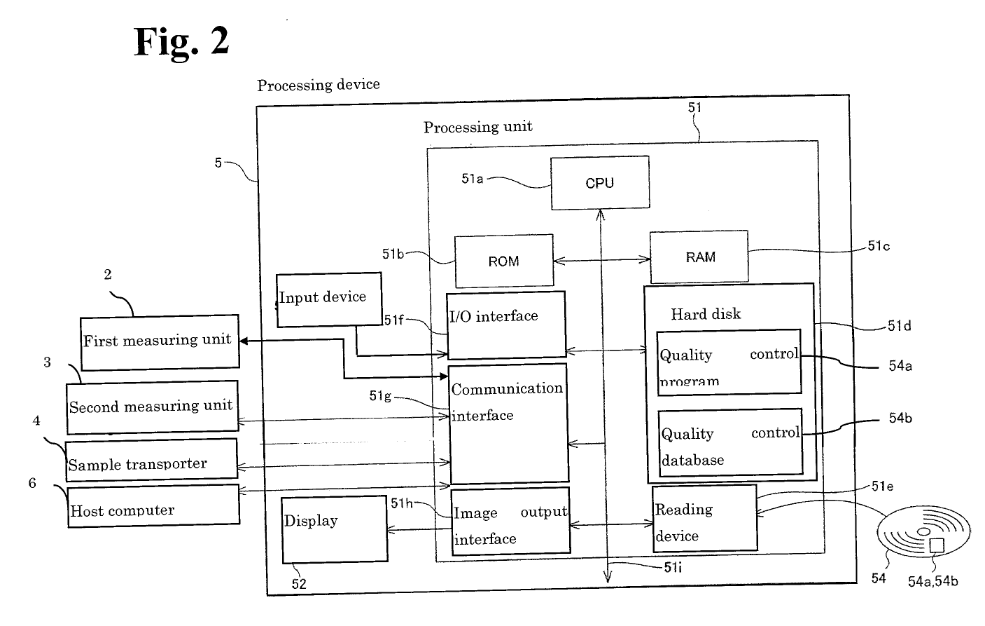

As shown in FIG. 2, the processing apparatus 5 is a computer (PC), and includes a processing unit 51 configured by a CPU, ROM, and RAM, a display unit 52, and an input device 53. The display unit 52 is provided to show the analysis results and quality control data obtained by analyzing digital signal data received from the first measuring unit 2 and the second measuring unit 3.

The processing unit 51 is mainly configured by a CPU 51a, ROM 51b, RAM 51c, hard disk 51d, reading device 51e, I/O interface 51f, communication interface 51g, image output interface 51h. The CPU 51a, ROM 51b, RAM 51c, hard disk 51d, reading device 51e, I/O interface 51f, communication interface 51g, and image output interface 51h are connected by a bus 51i.

The CPU 51a is capable of executing a computer program stored in the ROM 51b and a computer program loaded in the RAM 51c. The computer functions as the processing apparatus 5 of the present embodiment when the CPU 51a executes an application program 54a in a manner described below.

The hard disk 51d holds various installed computer programs that are executed by the CPU 51a, including an operating system and application program.

Installed on the hard disk 51d in addition to the quality control computer program 54a is a quality control database 54b that records quality control data of measurement and analysis results of quality control samples performed by the first measuring unit 2 and the second measuring unit 3.

The reading device 51e is configured by a flexible disk drive, CD-ROM drive, DVD-ROM drive or the like, and is capable of reading computer programs or data recorded on a portable recording medium 54. Application programs 54a and 54b are stored on the flexible recording medium 54, and these application programs 54a and 54b can be read from the flexible recording medium 54 by a computer so as to be installed on the hard disk 51d.

Note that the application programs 54a and 54b can be provided not only by the flexible recording medium 54, but also can be provided via an electrical communication line from an external device that is capable of communicating with the computer over the electrical communication line (land-line or wireless). For example, the application programs 54a and 54b may be stored on the hard disk of a server computer on a network, such that the computer can access the server computer to download the application programs 54a and 54b, which are then installed on the hard disk 51d.

Also installed on the hard disk 52d is an operating system that provides a graphical user interface environment, such as, for example, Windows (registered trademark) by Microsoft Corporation. In the following description, the application program 54a operates in the environment of such an operating system.

The input device 53 is connected to the I/O interface 51f so that a user can input data to the computer and operate the computer.

In place of a normal sample, the sample analyzer 1 can measure and analyze a quality control sample in the same manner as a normal blood sample to assure the accuracy of the sample analyzer 1. The quality control value (analysis result of the quality control sample) obtained when the measuring units 2 and 3 measure the quality control sample are recorded in the quality control database 54b.

The quality control computer program 54a performs statistical processing of the quality control data and displays the quality control values recorded in the quality control database 54b as a time-series quality control graph (QC chart) on the display 52.

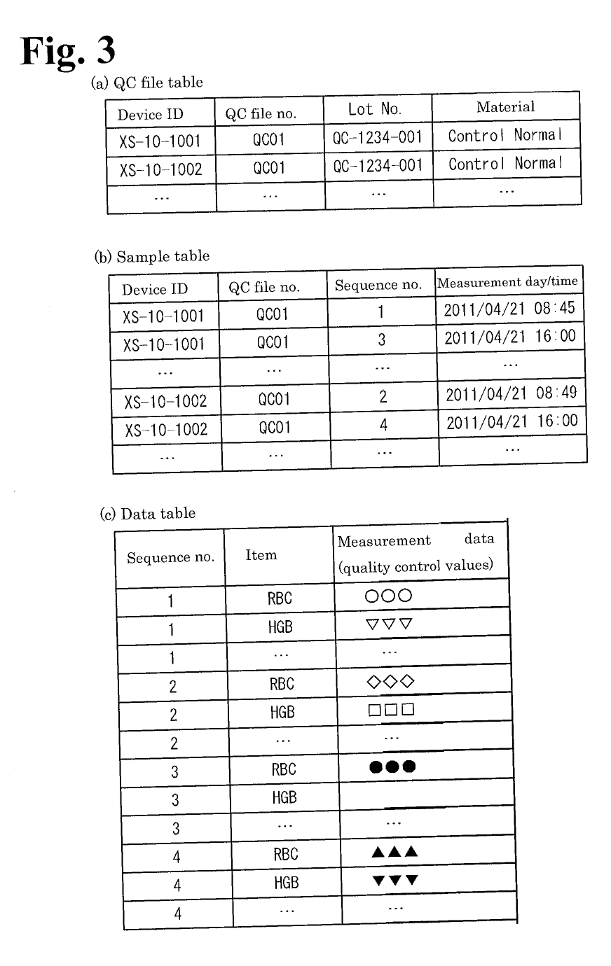

FIG. 3 shows the quality control database 54b. The quality control database is a relational database configured by three tables, a QC file table, sample table, and data table.

The file table shown in FIG. 3(a) includes items of device ID, QC file no., lot no., and material.

The device ID is an identifier for identifying the measuring unit 2 and measuring unit 3 incorporated in the sample analyzer 1. The device ID “XS-10-1001” is assigned to the first measuring unit 2, and “XS-10-1002” is assigned to the second measuring unit 3.

The “QC file no.” represents the file name (number) of the quality control data stored in the sample analyzer 1. One QC file is configured as a set of quality control values of the measurement results obtained by the measuring units 2 and 3 for a specific material from a specific lot number, and a plurality of QC files may be saved.

“Lot no.” represents the lot number of the quality control sample, and “material” is the type of quality control sample. Each quality control sample is uniquely identified by the “lot no.” and “material.” That is, the “lot no.” and “material” are identifiers of the quality control sample.

The sample table shown in FIG. 3(b) includes items of “device ID”, “QC file no.”, “sequence no.”, and “measurement date and time”. The sample table and the QC file table are associated by the QC file number, or the device ID.

The “sequence no.” is the number assigned when measuring the quality control sample, and the “measurement date and time” is the date and time on which the quality control sample is measured.

The data table shown in FIG. 3(c) has “sequence no.”, “item”, and “measurement data.” The data table and the sample table are associated by the sequence number.

“Item” represents the measurement item of the quality control sample. Measurement data are obtained for a plurality of measurement items in a single measurement (analysis) of the quality control sample.

“Measurement data” represents the measurement data (quality control values) of each measurement item.

Since the quality control database 54b is configured as mentioned above, when a QC file number and device ID are specified, the quality control data can be obtained for the set of the plurality of quality control values resulting from measuring a specific quality control sample by the measuring unit 2 and 3 specified by the device ID.

That is, the quality control data recorded in the quality control database 54b are time series data composed of sets of a plurality of measurement data (quality control values obtained by measuring a specific quality control sample by a specific measuring unit on a plurality of measurement dates and times. A plurality of quality control data may be stored in the quality control database 54b.

The processing unit 51 performs processing to display the quality control values recorded in the quality control database 54b as quality control graphs (QC charts) in time series on the display 52 based on the quality control computer program 54a.

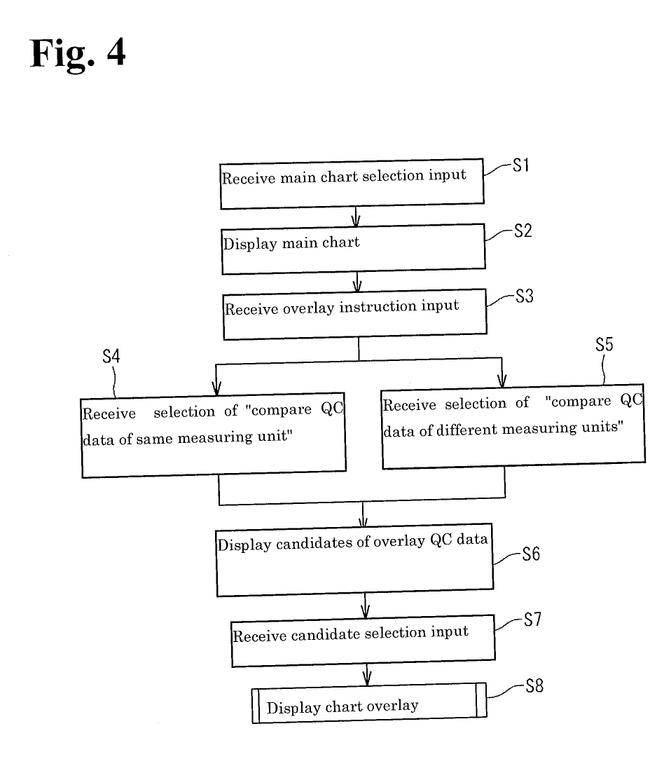

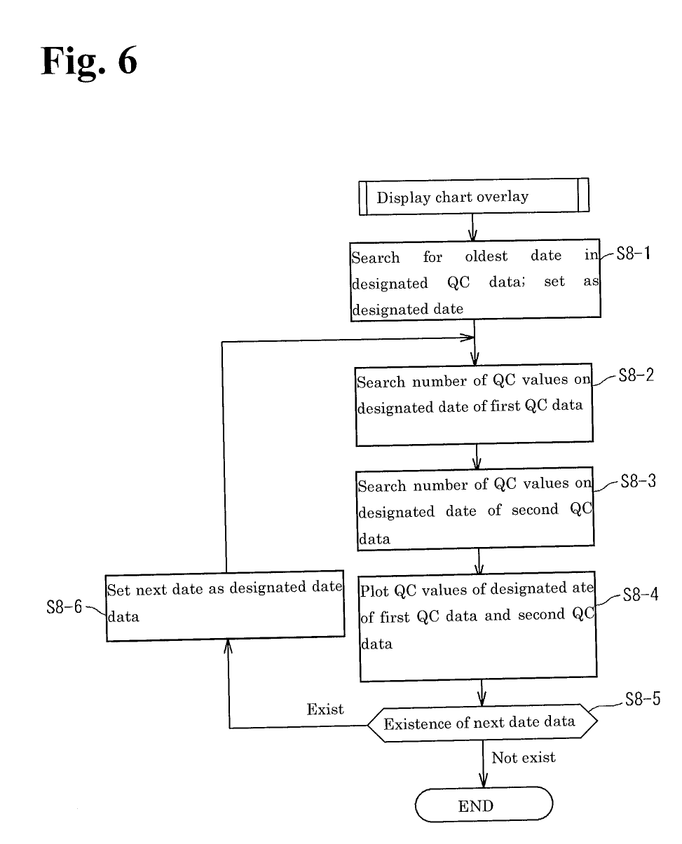

FIG. 4 shows the sequence when a plurality (two) quality control graphs (QC charts) are displayed simultaneously. Note that in the processing sequence shown in FIG. 4 this sequence is accomplished when the processing unit 51 executes the quality control computer program 54a. To facilitate the description, the example pertains to the selection of two quality control data sets overlaid on the screen 10 (to be described later); however, the present invention is not limited to only two overlaid quality control data sets inasmuch as more than two sets also may be overlaid. For example, if three quality control data sets are selected on screen 10, the present invention shows the selected three data sets on a screen 20 (described later) according to the overlay process shown in FIG. 6.

The sequence described below pertains to when a quality control graph is overlaid on another quality control graph. The processing unit 51 receives the input of the selected main chart (one quality control graph) shown on the display 52 (step S1). The input selection is accomplished by the processing unit 51 showing the list of quality control data (QC charts) recorded in the quality control database 54b, and the user using the input device 53 to select the list shown on the screen on the display 52.

The processing unit 51 shows, on the display 52, the quality control graph (QC chart) plotting a plurality of quality control values included in the selected quality control data at fixed intervals in the measurement date/time sequence (step S2).

When the processing unit 51 receives an overlay instruction to overlay one QC chart (another quality control graph) over the main chart (step S3), the processing unit 51 then receives the input selection of the method of QC chart comparison (overlay) (steps S4, S5). Note that the input of the overlay instruction in step S3 is accomplished by the processing unit 51 showing a button region for the overlay instruction input in the main chart display screen, and the user using the input device 53, such as a mouse or the like, to select the button region.

The methods of QC chart comparison (overlay) include comparing a plurality of quality control data (QC charts) measured by the same measuring unit (step S4), and comparing a plurality of quality control data (QC charts) measured by a plurality of different measuring units (step S5).

When the input of the comparison (overlay) method selection is received, the processing unit 51 receives an overlay instruction, shows the choices for selecting either comparison (overlay) method on the display 52, and the user selects the desired choice by using the input device 52, such as a mouse.

The processing unit 51 then shows a list of quality control data (QC chart) candidates on the display 52 based on the other QC charts (quality control graph) to be overlaid on the main chart.

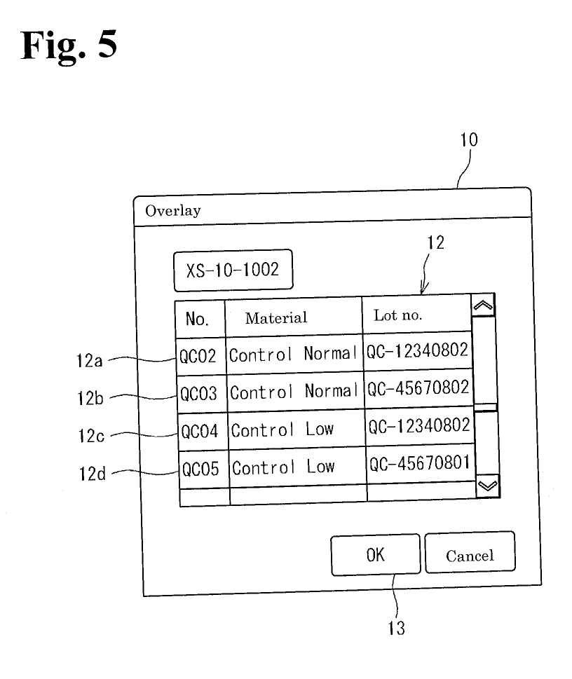

FIG. 5 shows an example of the screen 10 that displays the list of candidates. Note that in FIG. 5 the screen shows a situation of step S5 for comparing a plurality of quality control data measured by a plurality of different measuring units.

The displayed quality control data candidates are extracted by the processing unit 51 from the plurality of quality control data recorded in the database 54b according to a predetermined extraction condition. The processing unit 51 shows the extracted candidates on screen 10 of the display 52 sorted by a predetermined sorting condition.

When “compare a plurality of quality control data measured by the same measuring unit” is selected in step S4, extraction of candidates can be accomplished by, for example, using the AND condition listed in 1) through 4) below as the predetermined extraction condition.

1) Main chart and quality control data of the same measuring unit.

2) Quality control data of quality control samples of a registered lot.

3) Main chart and same material.

4) Without main chart.

When “compare a plurality of quality control data measured by a plurality of different measuring units” is selected in step S5, extraction of candidates can be accomplished by, for example, using the AND condition listed in 1) through 3) below as the predetermined extraction condition.

1) Main chart and quality control data of different measuring units.

2) Quality control data of quality control samples of a registered lot.

3) Main chart and same material.

The number of candidates to be displayed can be reduced by narrowing the many quality control data in the database 54b for display using a predetermined extraction condition, hence facilitating ease of candidate selection by the user. Suitable candidates may be extracted since a different method of extraction is used according to the method of comparison (overlay).

The plurality of candidates of quality control data extracted by the above extraction method may be sorted by, for example, a first sorting condition of the lot registration date in descending order, a second sorting condition of the lot number in ascending order, and a third sorting condition of the QC file number in ascending order. Note that the first sorting condition has priority, and sorting is performed by the second condition and third condition in sequence.

The user can easily select candidates by sorting and displaying quality control data with a high possibility of overlay at the top (high order).

The candidate list extracted from the quality control database 54b is shown in the candidate display area 12 of the screen 10. In FIG. 5, a plurality of candidates 12a, 12b, 12c, and 12d are shown. The user selects candidates 12a, 12b, 12c, and 12d using the input device 53 such as a mouse. When the “OK button” is selected in screen 10, the selected candidate is confirmed as the quality control data for main chart overlay (step S7).

When the processing unit 51 receives the candidate selection input in step S7, the processing unit 51 performs processing to overlay the QC chart of the selected quality control data on the main chart (step S8).

FIG. 6 shows details of the overlay process of step S8.

The quality control data for the overlay (the underlying quality control data and the superimposed quality control data) are not limited to quality control values measured at the same time, and may be quality control values of different measurement frequency (for example, the number of measurements per day).

The overlay process shown in FIG. 6 suggests to the user QC charts of such quality control data for ease of comparison.

The processing unit 51 first searches the oldest day of the measurement dates among the plurality of quality control data of the overlay and sets that day as the designated date for the QC chart (step S8-1).

The processing unit 51 then searches for the number ml quality control values on the designated date as the first quality control data to be the basis of the main chart (step S8-2). The processing unit 51 then searches for the number n1 quality control value on the designated date as the second quality control data to be overlaid on the main chart (step S8-3).

The processing unit 51 plots on the chart one ml quality control value on the designated date of the first quality control data at predetermined intervals (plot intervals) in the measurement time sequence starting from the initial position (oldest date) on the time axis of the chart (step S8-4). That is, in the chart of the first quality control data (main chart), one ml quality control value is plotted at equal intervals from the initial position of the chart.

Similarly, the processing unit 51 plots on the chart one n1 quality control value on the designated date of the second quality control data at predetermined intervals (plot intervals) in the measurement time sequence starting from the initial position (oldest date) on the time axis of the chart (step S8-4). That is, in the chart of the second quality control data (overlay chart), one n1 quality control value is plotted at equal intervals from the initial position of the chart.

The processing unit 51 confirms the existence of a quality control value a next date (step S8-5); when a quality control value of a next date exists, this day is set as the designated date (step S8-6), and the process returns to step S8-2.

The processing unit 51 again searches for the number m2 quality control value on the designated date of the first quality control data (step S8-2), and searches for the n2 quality control value on the designated date of the second quality control data (s8-3).

If m1≧n1 when plotting the m2 quality control value on the designated date of the first quality control data, the processing unit 51 then plots the m2 quality control value at the predetermined interval in the measurement time sequence from the next plot position (m1+1) at the predetermined interval from the ml quality control value from the initial position of the chart. If m1<n1, however, the processing unit 51 plots the m2 quality control value at the predetermined interval in the measurement time sequence from the next plot position (n1+1) at the predetermined interval from the n1 plot position from the initial position of the chart (step S8-4).

If n1≧m1 when plotting the n2 quality control value on the designated date of the second quality control data, the processing unit 51 then plots the n2 quality control value at the predetermined interval in the measurement time sequence from the next plot position (n1+1) at the predetermined interval from the n1 quality control value from the initial position of the chart. If n1<m1, however, the processing unit 51 plots the n2 quality control value at the predetermined interval in the measurement time sequence from the next plot position (m1+1) at the predetermined interval from the ml plot position from the initial position of the chart (step S8-5).

The processes of steps S8-2 through S8-4 are performed until the designated date reaches most recent date in the quality control data.

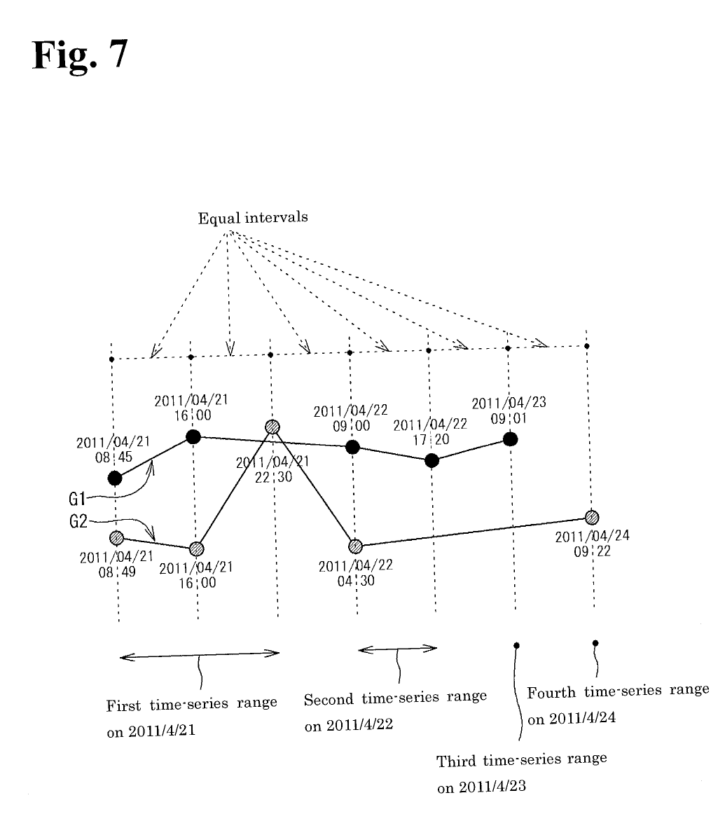

FIG. 7 shows part of the quality control graphs G1 and G2 in which a plurality of quality control data are plotted via steps S8-2 through S8-4.

Here, the number of quality control values for the measurement day 2011/4/21 is m1=2 in the first quality control graph G1, and n1=3 in the second quality control graph G2. The number of quality control values for the next measurement day, 2011/4/22, is m2=2 in the first quality control graph G1, and n2=1 in the second quality control graph G2. The number of quality control values for the measurement day 2011/4/23 is m3=1 in the first quality control graph G1, and n3=0 in the second quality control graph G2. The number of quality control values for the measurement day 2011/4/24 is m4=0 in the first quality control graph G1, and n4=1 in the second quality control graph G2.

Observation of the largest (maximum) number of quality control values (maximum plot number) in a quality control graph discloses n1=3 on 2011/4/21, m2=2 on 2011/4/22, m3=1 on 2011/4/23, and n4=1 on 2011/4/24.

The range in the time axis direction (time-series range) plotted on each measurement day in correspondence to the maximum plot number, is a 3-plot range on 2011/4/21, 2-plot range on 2011/4/22, 1-plot range on 2011/4/23, and 1-plot range on 2011/4/24. Note that the time-series range per each measurement day (unit period) is different.

In the present embodiment, therefore, the time-series range per measurement day (unit period) is the same in the plurality of quality control graphs G1 and G2 even though the number of quality control values of each measurement day (unit period) is different between the plurality of quality control graphs G1 and G2 (quality control data).

For example, on 2011/4/21, the first time-series range per that day is a 3-plot range, but the number of quality control values m1=2 in the first quality control graph G1, and the two quality control values are plotted packed to the left within the first time-series range (packed on the oldest time side on the time axis).

Although the times of the quality control values are different between the plurality of quality control graphs G1 and G2, the quality control values of either of graph G1 and G2 can be plotted at a predetermined plot position of the predetermined plot interval.

Since the quality control values on 2011/4/22, that is, the day following 2011/4/21, are plotted at the fourth plot position from the left as the next plot position since the quality control values are plotted up to the third plot position from the left on 2011/4/21 in the second quality control graph G2.

Although the quality control value is only plotted to the second plot position from the left on 2011/4/21 in the first quality control graph G1, the quality control value is plotted at the fourth plot position from the left in time series similar to the second quality control graph G2 because up to the third plot position from the left is in the first time-series range of 2011/4/21.

Plots are similar on later dates, and a line graph (chart) is generated with each plot position connected by a line.

Accordingly, the first quality control graph G1 and the second quality control graph G2 obtained with different measurement numbers for each day (unit period) can be easily compared when overlaid on the same screen as shown in FIG. 7. That is, the graph with the fewest quality control values on each measurement day has fewer skipped plots than the graph with the most quality control values, hence the position in the time axis of the graph is not different in the first quality control graph G1 and the second quality control graph G2. The quality control values of each measurement day are thus easily compared.

Note that the plurality of the quality control graphs G1 and G2 are shown in different colors to render the two graphs easily identifiable.

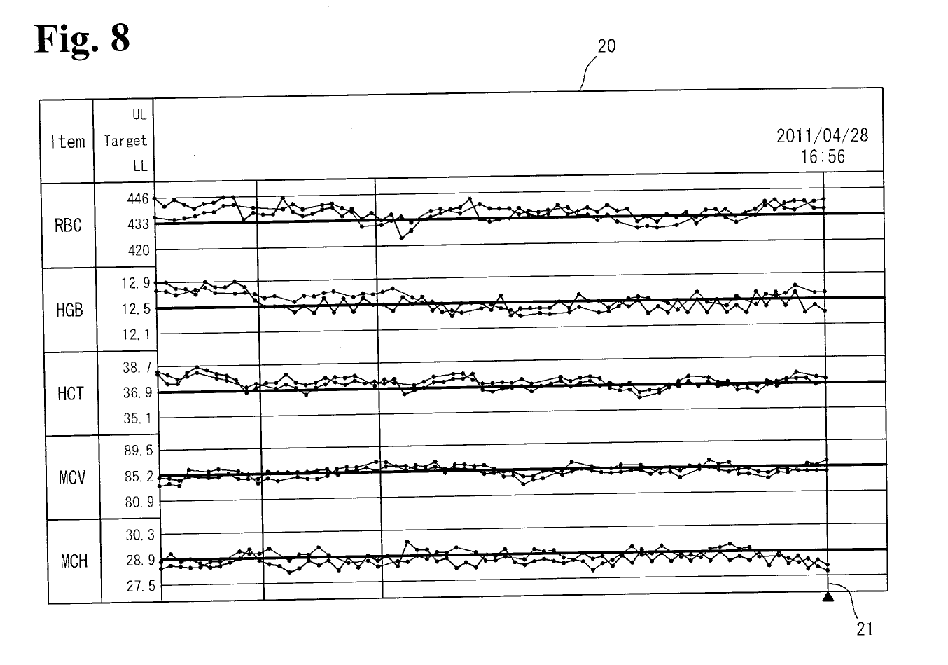

The overlay display process shown in FIG. 6 is performed for each of the plurality of measurement items included in the quality control data. FIG. 8 shows an example of screen 20 with a plurality of overlaid quality control graphs for a plurality of measurement items (RGB, HGB, HCT, MCV, MCH). In screen 20, the cursor line 21 can be moved on the graph, and the date indicated by the cursor 21 is displayed near the cursor line 21. In this way the plurality of measurement items can be easily compared by overlaying the respective graphs of the plurality of measurement items.

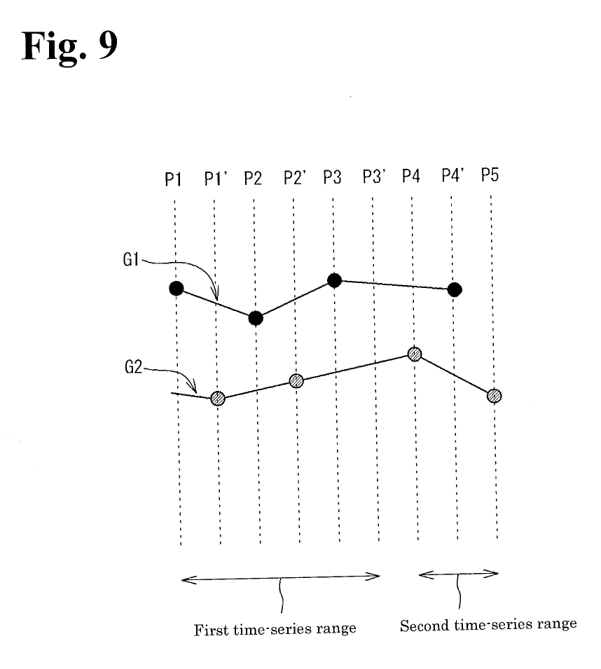

FIG. 9 shows an example of a modification of the plotting method. In FIGS. 7 and 8 the graph with the fewest number of quality control values on each measurement day plots the quality control values at the same plot positions as the plot position of the graph with the most quality control values. However, in FIG. 9, the graph with the fewest quality control values is plotted at different positions than the plot positions of the graph with the most quality control values although within the same time-series range. In this way the plot positions of both graphs need not be the same positions insofar as the plot positions are within the same time-series range of the measurement day (unit period).

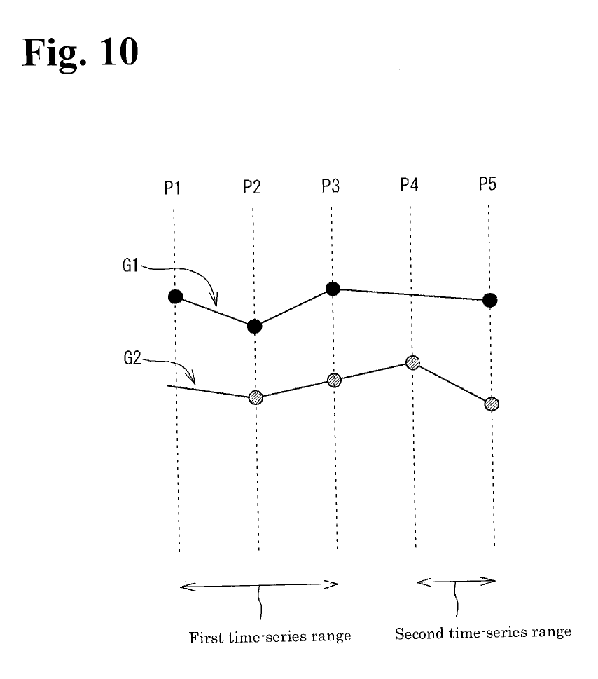

FIG. 10 shows an example of another modification of the plotting method. In FIGS. 7 and 8 the graph with the fewest number of quality control values on each measurement day plots the quality control values packed to the left, whereas the values are plotted packed to the right in FIG. 10.

Note that the present invention is not limited to the above embodiment. For example, although the time series range is set for each day as a one day unit period in the above embodiment, it is to be noted that one hour, several hours, or several days may be used as the unit period and the time series range may be set for each of these unit periods.

The selection of quality control data for the overlay display is accomplished by selecting either “compare quality control data of the same measuring unit” or “compare quality control data of different measuring units” in the above embodiment. However, both also may be selected. For example, when two measuring units and two types of a QC files are selected, a total of four QC charts can be overlaid and displayed.

The plurality of quality control graphs need not be overlaid, and may be simply shown side-by-side. In this case, the plotting of each quality control graph can be shown in the time series range of each unit period.

The function of the processing apparatus (data processing apparatus 5) is not limited to functioning as part of the sample analyzer 1, and may be part of a computer (host computer 6 or the like) connected to the sample analyzer 1 through a network. In this case, the computer that functions as the quality control device may receive and store the quality control values (quality control data) from the sample analyzer 1 through the network.

What is claimed is:

1. A sample analyzer comprising: a measuring section for analyzing components in a sample;
a memory section for storing first quality control data, which are time-series data that include at least one quality control value obtained by the measuring unit measuring a quality control sample, and second quality control data, which are time-series data that include at least one quality control value;
a display; and
a processing section for showing, on the display, a screen that includes a first quality control graph plotted by a time-series of quality control values contained in the first quality control data stored in the memory unit, and a second quality control graph plotted by a time-series of quality control values contained in the second quality control data stored in the memory unit;
wherein
when a first number of quality control values are included in the first quality control data in a predetermined period and a second number of quality control values, which is different from the first number, are included in the second quality control data in the predetermined period, the processing section shows, on the screen, the first quality control graph of the first number of quality control values plotted in a range in the direction of the time axis of the graph and a second quality control graph of the second number of the second quality control values plotted in the range.

2. The sample analyzer of claim 1, wherein the measuring section comprises
a first measuring unit and a second measuring unit;
the first and second quality control data are obtained by the first measuring unit measuring a quality control sample.

3. The sample analyzer of claim 1, wherein the measuring section comprises
a first measuring unit and a second measuring unit;
the first quality control data are obtained by the first measuring unit measuring a quality control sample; and
the second quality control data are obtained by the second measuring unit measuring a quality control sample.

4. The sample analyzer of claim 1, wherein the second quality control graph that plots the second number of quality control values in the range plots the second number of quality control values at certain spacing in the range when the second number is greater than the first number.

5. The sample analyzer of claim 4, wherein the first quality control graph, which plots the first number of quality control values in the range, plots the quality control values at the same plot positions as any of the plot positions of the second quality control graph, which plots the second number of quality control values in the range.

6. The sample analyzer of claim 5, wherein the quality control values of the first quality control graph, which plots the first number of quality control values in the range, are plotted packed on the distant past time side in the direction of the time axis of the graph.

7. The sample analyzer of claim 1, wherein the processing section displays the first and second quality control graphs in an overlaid condition in the same region of the screen.

8. The sample analyzer of claim 1, wherein the first and second quality control data respectively comprise quality control values for a plurality of measurement items; and
the processing section displays the first and second quality control graphs in an overlaid condition for each measurement item.

9. The sample analyzer of claim 1, wherein the memory section stores third quality control data, which are time-series data including at least one quality control value; and
the processing section shows a selection screen for selecting the first through third quality control data stored in the memory section, and shows the first and second quality control graphs on the display when the first and second quality control data are selected in the selection screen.

10. The sample analyzer of claim 9, wherein the processing section
shows, on the selection screen, a plurality of quality control data extracted according to predetermined extraction condition from among the first through third quality control data stored in the memory section.

11. The sample analyzer of claim 10, wherein the processing section shows on the selection screen a plurality of extracted quality control data sorted by a predetermined sorting condition.

12. The sample analyzer of claim 1, wherein the predetermined period is a predetermined length; and
the processing section shows, on the screen, the first quality control graph of the third number of quality control values plotted in a second range in the direction of the time axis of the graph and a second quality control graph of the fourth number of quality control values plotted in the second range when a third number of quality control values are included in the first quality control data in a second predetermined period that is different from the predetermined period and the fourth number of quality control values, which is different from the third number, are included in the second quality control data in the second predetermined period.

13. The sample analyzer of claim 12, wherein the second quality control graph that plots the fourth number of quality control values in the second range plots the fourth number of quality control values at certain spacing in the second range when the fourth number is greater than the third number.

14. The sample analyzer of claim 13, wherein the first quality control graph, which plots the third number of quality control values in the second range, plots the quality control values at the same plot positions as any of the plot positions of the second quality control graph, which plots the fourth number of quality control values in the second range.

15. The sample analyzer of claim 14, wherein the quality control values of the first quality control graph, which plots the third number of quality control values in the second range, are plotted packed on the distant past time side in the direction of the time axis of the graph.

16. The sample analyzer of claim 1, wherein the memory section stores third quality control data, which are time-series data including at least one quality control value; and
the processing section shows, on the screen, the first quality control graph of the first number of quality control values plotted in the range, a second quality control graph of the second number of quality control values plotted in the range and a third quality control graph of a fifth number of quality control values plotted in the range when the first number of quality control values are included in the first quality control data in a predetermined period, the second number of quality control values are included in the second quality control data in the predetermined period and the fifth number of quality control values are included in the third quality control data in the predetermined period.

17. The sample analyzer of claim 16, wherein the third quality control graph that plots the fifth number of quality control values in the range plots the fifth number of quality control values at certain spacing in the range when the fifth number is greatest among the first number, second number and fifth number.

18. The sample analyzer of claim 17, wherein the first quality control graph, which plots the first number of quality control values in the range and the second quality control graph, which plots the second number of quality control values in the range, plot the quality control values at the same plot positions as any of the plot positions of the third quality control graph, which plots the fifth number of quality control values in the range.

19. A data processing apparatus, comprising:
a memory section for storing first quality control data, which are time-series data that include at least one quality control value obtained by a measuring unit measuring components in a sample, and second quality control data, which are time-series data that include at least one quality control value;
a display; and
a processing section for showing, on the display, a screen that includes a first quality control graph plotted by a time-series of quality control values contained in the first quality control data stored in the memory unit, and a second quality control graph plotted by a time-series of quality control values contained in the second quality control data stored in the memory unit;
wherein
when a first number of quality control values are included in the first quality control data in a predetermined period and a second number of quality control values, which is different from the first number, are included in the second quality control data in the predetermined period, the processing section shows, on the screen, the first quality control graph of the first number of quality control values plotted in a range in the direction of the time axis of the graph and a second quality control graph of the second number of the second quality control values plotted in the range.
